(19) United States
(12) Patent Application Publication
(10) Pub. No.: US 2023/0128958 A1
(43) Pub. Date: Apr. 27, 2023

(54) SINGLE-FREQUENCY LASER APPARATUS

(71) Applicant: Fraunhofer UK Research Ltd, (US)

(72) Inventors: Alexander Lagatsky, Glasgow (GB); Loyd McKnight, Glasgow (GB); David Stothard, Glasgow (GB)

(73) Assignee: Fraunhofer UK Research Ltd, Glasgow (GB)

(21) Appl. No.: 17/912,169

(22) PCT Filed: Mar. 22, 2021
(86) PCT No.: PCT/GB2021/050701

§ 371 Date: Sep. 16, 2022

(30) Foreign Application Priority Data
Mar. 23, 2020 (GB) 2004167.9

(51) Int. Cl. H01S 3/08; H01S 3/16; H01S 3/0941; H01S 3/136; H01S 3/13; H01S 3/06; H01S 3/08031; H01S 3/094; H01S 3/1055; H01S 3/04

(52) U.S. Cl. CPC H01S 3/08059; H01S 3/08009; H01S 3/1625; H01S 3/09415; H01S 3/136; H01S 3/1305; H01S 3/0619; H01S 3/08031; H01S 3/094096; H01S 3/1304; H01S 3/1055; H01S 3/0401; H01S 3/1636

(57) ABSTRACT

A single-frequency laser apparatus comprises a mirror and a volume Bragg grating (VBG) reflector defining a laser cavity therebetween and an optical gain material for emitting and amplifying an intra-cavity beam in the laser cavity. The optical gain material comprises a transition-metal doped crystal such as a crystal doped with transition-metal ions selected from one or more of Ti³⁺ ions, Cr²⁺ ions, Cr³⁺ ions or Cr⁴⁺ ions. A reflectivity spectrum of the VBG reflector and an optical length of the laser cavity are selected so that a beam output from the laser cavity is a single-frequency output beam and/or includes only one longitudinal mode of the laser cavity. The laser apparatus may provide a robust, compact, low cost, high-power wavelength adjustable (from approximately 650 to 950 nm), narrow linewidth (<100 kHz), single frequency laser source which is suitable for a wide range of applications from laser sensing, spectroscopy, and high precision frequency metrology sectors.

### FIELD

The present disclosure relates to a single-frequency laser apparatus and, in particular though not exclusively, to a widely-tuneable, frequency-stabilised, single-frequency laser apparatus.

### BACKGROUND

Single-frequency widely-tuneable lasers are known which are capable of single-frequency, narrow-linewidth (<100 kHz) continuous-wave operation over a broadband tuning range. For example, Ti:sapphire lasers are known which are capable of single-frequency, narrow-linewidth (<100 kHz), continuous-wave operation over an approximate tuning range of 650 to 1100 nm. Such known single-frequency, widely-tunable lasers may be used for a wide range of technical applications such as laser sensing, spectroscopy, high precision metrology, and laser cooling. However, such known single-frequency widely-tunable lasers are generally complex and/or are relatively large in size.

### SUMMARY

According to an aspect of the present disclosure there is provided a single-frequency laser apparatus, comprising:

a mirror and a volume Bragg grating (VBG) reflector defining a laser cavity therebetween; and

an optical gain material for emitting and amplifying an intra-cavity beam in the laser cavity,

wherein the optical gain material comprises a transition-metal doped crystal such as a crystal doped with transition-metal ions selected from one or more of Ti³⁺ ions, Cr²⁺ ions, Cr³⁺ ions or Cr⁴⁺ ions.

The laser apparatus may be configured so that the VBG reflector reflects a single longitudinal mode of the laser cavity

A reflectivity spectrum of the VBG reflector and an optical length of the laser cavity may be selected so that a beam output from the laser cavity is a single-frequency output beam and/or includes only one longitudinal mode of the laser cavity

The VBG reflector may have a reflectivity spectrum which has a full-width half maximum reflectivity spectral bandwidth which is comparable to, is equal to, or less than, a free spectral range (FSR) of the laser cavity.

The laser cavity may be a Fabry-Perot laser cavity, a linear laser cavity, or a standing-wave laser cavity. Such laser cavity configurations may result in a shorter laser cavity and a longer FSR. This means that the VBG reflector may have a greater full-width half maximum reflectivity spectral bandwidth whilst still ensuring single-frequency operation of the laser apparatus. This may be advantageous because it may be easier to manufacture VBG reflectors with greater full-width half maximum reflectivity spectral bandwidths.

The transition-metal dopant ions of the optical gain material may be distributed throughout the optical gain material. Excessive doping of the optical gain material for increased absorption at an optical pump wavelength, can degrade the quality of the optical gain material so as to increase parasitic absorption at an emission wavelength of the optical gain material to such an extent that it is inefficient, impractical or not possible for the laser apparatus to reach threshold when using an optical gain material that is too heavily doped. However, the inventors have discovered that the use of a VBG reflector having a reflectivity spectral bandwidth which is sufficiently narrow may facilitate the use of a longer, less heavily-doped optical gain material to allow single-frequency operation of the laser apparatus which has a relatively simple, relatively compact, and relatively robust optical cavity configuration.

The VBG reflector may have a reflectivity spectrum which has a full-width half maximum reflectivity spectral bandwidth in the range of 10 GHz to 50 GHz, 15 GHz to 40 GHz, or 20 GHz to 30 GHz.

The laser cavity may have a single pass optical length in the range of 3 mm to 15 mm, 4 mm to 10 mm, or 5 mm to 7.5 mm.

A FSR of the laser cavity may be in the range of 10 to 50 GHz, 15 to 37.5 GHz or 20 to 30 GHz.

A Bragg wavelength or centre wavelength of the VBG reflector may be in the range 0.4 μm to 3 μm. The intra-cavity beam may be unguided.

The optical gain material may have a uniform and/or a homogeneous composition.

The optical gain material may have a uniform and/or a homogeneous structure.

The laser apparatus may comprise an optical gain medium, wherein the optical gain medium comprises the optical gain material.

The optical gain medium may consist of the optical gain material.

The optical gain medium may comprise one or more coatings applied to, or formed on, the optical gain material.

Each coating may be anti-reflecting across at least part of a spectral gain bandwidth of the optical gain material.

The optical gain medium may consist of the optical gain material and the one or more coatings applied to, or formed on, the optical gain material.

There may be no optical components located between the optical gain medium and the mirror.

The optical gain medium and the mirror may be separated by a gap such as an air gap.

The optical gain medium and the mirror may be separated by a material which bonds the optical gain medium and the mirror together. For example, the optical gain medium and the mirror may be separated by an adhesive or an epoxy or the like.

There may be no optical components located between the optical gain medium and the VBG reflector.

The optical gain medium and the VBG reflector may be separated by a gap such as an air gap.

The optical gain medium and the VBG reflector may be separated by a material which bonds the optical gain medium and the VBG reflector together. For example, the optical gain medium and the VBG reflector may be separated by an adhesive or an epoxy or the like.

If there no optical components located between the mirror and the optical gain medium and/or if there no optical components located between the VBG reflector and the optical gain medium, the optical length of the laser cavity may be shorter and the free spectral range (FSR) of the laser cavity may be longer. This means that the VBG reflector can have a greater full-width half maximum reflectivity spectral bandwidth whilst still ensuring single-frequency operation of the laser apparatus. This may be advantageous because it is easier to manufacture a VBG reflector with a greater full-width half maximum reflectivity spectral bandwidth. Moreover, if there are no additional optical components in the laser cavity between the mirror and the optical gain medium or between the VBG reflector and the optical gain medium, the gain medium can be longer for a given VBG spectral bandwidth and can, therefore, be less heavily-doped and of better optical quality.

The intra-cavity beam may be linearly polarised, for example the intra-cavity beam may be linearly polarised at all positions in the laser cavity.

There may be no polarisation-control elements, components or materials in the laser cavity.

If there no polarisation-control elements, components or materials in the laser cavity, the optical length of the laser cavity may be shorter and the free spectral range (FSR) of the laser cavity may be longer. This means that the VBG reflector can have a greater full-width half maximum reflectivity spectral bandwidth whilst still ensuring single-frequency operation of the laser apparatus. This may be advantageous because it is easier to manufacture a VBG reflector with a greater full-width hall maximum reflectivity spectral bandwidth. Moreover, if there are no polarisation-control elements, components or materials in the laser cavity between the mirror and the optical gain medium or between the VBG reflector and the optical gain medium, the gain medium can be longer for a given VBG spectral bandwidth and can, therefore, be less heavily-doped and of better optical quality.

The optical gain medium may define a first end surface disposed towards the mirror and an opposing second end surface disposed towards the VBG reflector.

A physical length of the optical gain medium may be in the range of 0.5 mm to 7 mm, 1 mm to 4.5 mm, or 1.5 mm to 3 mm.

The mirror may be configured to serve as a high reflector for the laser apparatus.

The mirror may be reflective, for example highly reflective, across at least part of a spectral gain bandwidth of the optical gain material.

The mirror may comprise a substrate defining a front surface disposed towards the optical gain medium and an opposing rear surface, wherein the mirror further comprises a mirror coating disposed on either the front or the rear surface of the substrate, wherein the mirror coating is configured to be reflective across at least part of a spectral gain bandwidth of the optical gain material.

The mirror coating may comprise a dielectric coating such as a multi-layer dielectric coating.

The front and rear surfaces of the substrate may be planar and parallel.

The front surface of the substrate may be curved, the rear surface of the substrate may be planar, and the coating may be disposed on the front surface of the substrate.

The substrate may comprise, or be formed from, glass such as fused silica glass

The substrate may comprise, or be formed from, an electro-optic (EO) material, wherein the coating is disposed on the rear surface of the substrate.

The VBG reflector may be configured to serve as an output coupler for the laser apparatus.

The VBG reflector may be configured to be partially reflective across at least part of a spectral gain bandwidth of the optical gain material.

The VBG reflector may comprise a VBG reflector body member, wherein a periodic refractive index profile, variation or modulation extends through the VBG reflector body member.

The VBG reflector body member may be formed from, or comprise, a photo-thermo-refractive (PTR) material such a PTR glass material.

The VBG reflector may be formed by exposing the PTR material to patterned or structured UV light or to an interference pattern formed using UV light to define a periodic profile, variation or modulation in a refractive index of the PTR material and then thermally treating, for example heating, the PTR material to permanently write or fix the periodic profile, variation or modulation in the refractive index of the PTR material.

The VBG reflector may define a front surface disposed towards the optical gain medium and an opposing rear surface.

The VBG reflector may comprise one or more coatings applied to, or formed on, the VBG reflector body member. Each coating may be anti-reflecting across at least part of a spectral gain bandwidth of the optical gain material.

The optical gain medium may be separated from the mirror by a first gap and the optical gain medium may be separated from the VBG reflector by a second gap. The first and second gaps length may be selected to be in the range of 0.1 mm to 0.5 mm.

The optical gain material and the mirror may be unitary. The mirror and the optical gain medium may together define a unitary composite mirror/optical gain component which is separated from the VBG reflector by a gap. The gap between the composite mirror/optical gain component and the VBG reflector may be less than or equal to 0.5 mm. The second end surface of the optical gain medium may be coated so as to be anti-reflecting across at least part of a spectral gain bandwidth of the optical gain material. The mirror may be attached, for example bonded, to the first end surface of the optical gain medium. The optical gain medium and the mirror may be formed separately and then attached to one another so as to define the unitary composite mirror/optical gain component. The optical gain medium and the mirror may be attached by bonding using an adhesive, an epoxy or the like. The mirror may comprise a coating disposed on the first end surface of the optical gain medium, wherein the coating may be configured to be reflective, for example highly-reflective, across at least part of a spectral gain bandwidth of the optical gain material. The coating may comprise a dielectric coating such as a multi-layer dielectric coating.

The optical gain material and the VBG reflector may be unitary. The optical gain medium and the VBG reflector may together define a unitary composite VBG reflector/optical gain component which is separated from the mirror by a gap. The gap between the composite VBG reflector/optical gain component and the mirror may be less than or equal to 0.5 mm. The first end surface of the optical gain medium may be coated so as to be anti-reflecting across at least part of a spectral gain bandwidth of the optical gain material. The rear surface of the VBG reflector body member may be coated so as to be anti-reflecting across at least part of a spectral gain bandwidth of the optical gain material. The front surface of the VBG reflector body member may be attached, for example bonded, to the second end surface of the optical gain medium. The optical gain medium and the VBG reflector may be formed separately and then attached to one another so as to define the unitary composite VBG reflector/optical gain component. The optical gain medium and the VBG reflector may be attached by bonding using an adhesive, an epoxy or the like.

The mirror, the optical gain material, and the VBG reflector may be unitary. The mirror, the optical gain medium, and the VBG reflector may together define a unitary composite cavity arrangement. The optical gain medium, the mirror, and the VBG reflector may be formed separately and then attached to one another so as to define a unitary composite cavity arrangement. The optical gain medium, the mirror, and the VBG reflector may be attached by bonding using an adhesive, an epoxy or the like.

The VBG reflector may be defined by, or in, the optical gain material.

The mirror, the VBG reflector, and the optical gain material may be arranged along an optical axis so that the intra-cavity beam propagates along the optical axis.

The laser apparatus may comprise an optical pump for generating an optical pump beam.

The laser apparatus may comprise one or more optical elements for optically coupling the optical pump beam from the optical pump to the optical gain material so as to optically pump the gain optical material.

The one or more optical elements may be configured to optically couple the optical pump beam from the optical pump to the optical gain material through the mirror.

The mirror may be configured to transmit the optical pump beam.

The optical pump may comprise a laser diode.

The laser diode may be configured to emit the optical pump beam in the wavelength range from 450-530 nm.

The laser diode may comprise indium gallium nitride (InGaN).

The optical pump and the one or more optical elements may be configured so as to direct the optical pump beam along an optical axis which extends through the mirror the optical gain material, and the VBG reflector.

The laser apparatus may comprise a further optical pump for generating a further optical pump beam.

The one or more optical elements may be configured to optically combine the optical pump beam and the further optical pump beam to form a combined optical pump beam, and to optically couple the combined optical pump beam to the optical gain material so as to optically pump the optical gain material.

The one or more optical elements may be configured to optically couple the combined optical pump beam to the optical gain material through the mirror.

The mirror may be configured to transmit the combined optical pump beam.

The further optical pump may comprise a further laser diode. The further laser diode may be configured to emit light in the wavelength range from 450-530 nm.

The further laser diode may comprise InGaN.

The optical pump and the further optical pump may be configured to emit light at different wavelengths in the wavelength range from 450-530 nm.

One of the optical pump and the further optical pump may be configured to emit light at a wavelength in one part of the range from 450-530 nm and the other one of the optical pump and the further optical pump may be configured to emit light at a wavelength in a different part of the range from 450-530 nm.

The one or more optical elements may comprise a dichroic mirror for combining the optical pump beam and the further optical pump beam to form the combined optical pump beam.

The one or more optical elements may comprise a polarising beam splitter for combining the optical pump beam and the further optical pump beam to form the combined optical pump beam.

At least one of the one or more optical elements may comprise one or more free-space beam-shaping optics.

At least one of the one or more optical elements may comprise at least one of an aspheric lens, a cylindrical lens, and a spherical lens.

At least one of the one or more optical elements may comprise an optical fibre such as a multi-mode optical fibre

The optical pump, the further optical pump and the one or more optical elements may be configured so as to direct the combined optical pump beam along the optical axis.

The VBG reflector may define a retractive index profile which varies periodically along a length of the VBG reflector.

The VBG reflector may define a refractive index profile which varies periodically along the length of the VBG reflector with a period which is different at different lateral positions across the VBG reflector.

The VBG reflector may define a refractive index profile which varies periodically along the length of the VBG reflector with a period which varies, for example fans-out, according to a lateral position across the VBG reflector.

The VBG reflector may be arranged relative to the optical axis with the length of the VBG reflector parallel to the optical axis, wherein the VBG reflector and the optical axis are moveable laterally relative to one another so as to vary the period of the refractive index profile of the VBG reflector to which the intra-cavity beam is exposed.

The VBG reflector may be moveable laterally relative to the optical axis so as to vary the period of the refractive index profile of the VBG reflector to which the intra-cavity beam is exposed.

The optical axis may be moveable laterally relative to the VBG reflector so as to vary the period of the refractive index profile of the VBG reflector to which the intra-cavity beam is exposed. For example, the optical pump beam may be moveable laterally relative to the VBG reflector so as to vary the period of the refractive index profile of the VBG reflector to which the intra-cavity beam is exposed or the combined optical pump beam may be moveable laterally relative to the VBG reflector so as to vary the period of the refractive index profile of the VBG reflector to which the intra-cavity beam is exposed

The laser apparatus may comprise a VBG reflector actuator for moving the VBG reflector laterally relative to the optical axis so as to vary the period of the refractive index profile of the VBG reflector to which the intra-cavity beam is exposed.

The laser apparatus may comprise a heater for heating the VBG reflector.

The laser apparatus may comprise a cooler for cooling the VBG reflector.

The laser apparatus may comprise a mirror actuator for exerting a force on the mirror along the optical axis and/or moving the mirror along the optical axis.

The mirror actuator may comprise a mechanical actuator or a piezo-electric actuator such as a PZT actuator.

The mirror, the optical gain material, and the VBG reflector may be unitary or may be in engagement, and the mirror actuator may be configured to compress the mirror the optical gain material, and the VBG reflector against a fixed member in a direction parallel to the optical axis. At least one of the mirror, the optical gain material, and the VBG reflector may comprise a material having a stress-dependent refractive index.

The laser apparatus may comprise an electro-optic (EO) material located in the laser cavity.

The EO material may comprise, or be formed from, MgO:LiNbO₃.

The mirror may comprise a substrate which comprises, or is formed from, the EO material, wherein the substrate defines a front surface disposed towards the optical gain material and an opposing rear surface, and wherein the mirror further comprises a coating disposed on the rear surface of the substrate, wherein the coating is configured to be reflective across at least part of a spectral gain bandwidth of the optical gain material.

The laser apparatus may comprise a controller.

The controller may be configured to control, vary and or modulate the one or more optical elements so as to control, vary and/or modulate an optical power of at least one of the optical pump beam, the further optical pump beam, and the combined optical pump beam. Controlling the optical power of at least one of the optical pump beam, the further optical pump beam, and the combined optical pump beam in this way may enable tuning of a wavelength or frequency of an output beam emitted from the laser cavity and/or frequency stabilisation of the output beam.

The controller may be configured to control, vary and/or modulate an electrical current used to drive the optical pump so as to control, vary and/or modulate an optical power of the optical pump beam. Controlling the electrical current used to drive the optical pump in this way may enable tuning of a wavelength or frequency of an output beam emitted from the laser cavity and/or frequency stabilisation of the output beam.

The controller may be configured to control, vary and/or modulate an electrical current used to drive the further optical pump so as to control, vary and/or modulate an optical power of the further optical pump beam. Controlling the electrical current used to drive the further optical pump in this way may enable tuning of a wavelength or frequency of an output beam emitted from the laser cavity and/or frequency stabilisation of the output beam.

The controller may be configured to control the VBG reflector actuator so as to control the relative lateral alignment between the VBG reflector and the optical axis Controlling the relative lateral alignment between the VBG reflector and the optical axis in this way may enable tuning of a wavelength or frequency of an output beam emitted from the laser cavity.

The controller may be configured to control the heater so as to control a temperature of the VBG reflector. Controlling the temperature of the VBG reflector in this way may enable tuning of a wavelength or frequency of an output beam emitted from the laser cavity.

The controller may be configured to control the cooler so as to control a temperature of the VBG reflector. Controlling the temperature of the VBG reflector in this way may enable tuning of a wavelength or frequency of an output beam emitted from the laser cavity.

The controller may be configured to control the mirror actuator so as to control a compression force exerted on at least one of the mirror, the optical gain material, and the VBG reflector along the optical axis. When at least one of the mirror, the optical gain material, and the VBG reflector comprises a material having a stress-dependent refractive index, controlling a compression force exerted on at least one of the mirror, the optical gain material, and the VBG reflector along the optical axis may vary the refractive index of at least one of the mirror, the optical gain material, and the VBG reflector so as to vary an optical path length of the cavity for the purposes of tuning a wavelength or frequency of an output beam emitted from the laser cavity and/or frequency stabilisation of the output beam.

The controller may be configured to control the mirror actuator so as to control a position of the mirror along the optical axis. Controlling the position of the mirror along the optical axis in this way may enable tuning of a wavelength or frequency of an output beam emitted from the laser cavity and/or frequency stabilisation of the output beam.

The controller may be configured to control, vary and/or modulate an electrical signal such as a voltage applied to the EO material. Controlling the electrical signal applied to the EO material in this way may enable tuning of a wavelength or frequency of a an output beam emitted from the laser cavity and/or frequency stabilisation of the output beam.

The laser apparatus may comprise an optical frequency reference system for frequency-stabilising a frequency of an output beam emitted from the laser cavity.

The optical frequency reference system may comprise a frequency-dependent optical transmission arrangement having a frequency-dependent optical transmission spectrum which defines a frequency-dependent slope or gradient in optical transmission around a frequency of the output beam emitted from the laser cavity. The frequency-dependent optical transmission arrangement may have a frequency-dependent optical transmission spectrum which includes an optical transmission feature such as an optical transmission peak or fringe to one side of a frequency of the output beam emitted from the laser cavity.

The optical frequency reference system may comprise:

one or more output optical elements for optically coupling at least a portion of the output beam emitted from the laser cavity to the frequency-dependent optical transmission arrangement; and

an optical detector for detecting an optical beam transmitted by the frequency-dependent optical transmission arrangement and for generating an electrical reference signal representative of an optical power of the optical beam transmitted by the frequency-dependent optical transmission arrangement.

The frequency-dependent optical transmission arrangement may comprise a Fabry-Perot cavity.

The frequency-dependent optical transmission arrangement may comprise an atomic or molecular vapour cell.

The optical transmission of the frequency-dependent optical transmission arrangement may be used to detect frequency changes in the output beam emitted from the laser cavity. For example, when a frequency of the output beam lies on a slope of a peak in the optical transmission spectrum of the optical transmission arrangement, the optical transmission arrangement translates a frequency change in the output beam emitted from the laser cavity into a change in intensity of the optical beam transmitted by the optical transmission arrangement. The optical detector may then detect a frequency-dependent intensity and convert this into a frequency-dependent electrical reference signal. For example, the optical detector may detect a frequency-dependent intensity and convert this into a frequency-dependent output voltage which can be used for comparison with a reference voltage at the controller. When a frequency of the output beam emitted from the laser cavity lies on a slope of the peak in the optical transmission spectrum of the optical transmission arrangement, the frequency of the output beam emitted from the laser cavity can thus be locked “side-of-fringe” to the transmission of the optical transmission arrangement to thereby stabilise the frequency (i.e. to narrow the linewidth) of the output beam emitted from the laser cavity.

The laser apparatus may be configured to implement other frequency stabilisation techniques such as “top-of-fringe” frequency stabilisation or Pound-Drever-Hall frequency stabilisation.

The optical frequency reference system may comprise a frequency-stabilised optical reference source such as a single-mode frequency-stabilised optical reference source or a frequency-stabilised optical frequency comb.

The optical frequency reference system may comprise:

an optical detector; and

one or more output optical elements for optically coupling at least a portion of an output beam emitted from the laser cavity to the optical detector and for optically coupling at least a portion of an output beam emitted from the frequency-stabilised optical reference source to the optical detector so as to generate an electrical reference signal representative of a frequency difference between a frequency of the output beam emitted from the laser cavity and a frequency of the output beam emitted from the frequency-stabilised optical reference source.

One of ordinary skill in the art will understand that the generated electrical reference signal may have a beat frequency equal in value to the difference between the frequency of the output beam emitted from the laser cavity and the frequency of the output beam emitted from the frequency-stabilised optical reference source.

The controller may be configured to control, vary and/or modulate an electrical signal such as a voltage applied to the EO material according to the electrical reference signal.

The controller may be configured to control the mirror actuator so as to control the position of the mirror along the optical axis according to the electrical reference signal.

The controller may be configured to control, vary and/or modulate the one or more optical elements so as to control, vary and/or modulate an optical power of at least one of the optical pump beam, the further optical pump beam, and the combined optical pump beam according to the electrical reference signal.

The controller may be configured to control, vary and/or modulate an electrical current used to drive the optical pump so as to control, vary and/or modulate an optical power of the optical pump beam according to the electrical reference signal.

The controller may be configured to control, vary and/or modulate an electrical current used to drive the further optical pump so as to control, vary and/or modulate an optical power of the further optical pump beam according to the electrical reference signal.

Controlling at least one of the electrical signal applied to the EO material according to the electrical reference signal, the position of the mirror along the optical axis according to the electrical reference signal, the optical power of at least one of the optical pump beam, the further optical pump beam, and the combined optical pump beam according to the electrical reference signal, and the electrical current used to drive the optical pump and/or the further optical pump according to the electrical reference signal may enable frequency stabilisation of the output beam emitted from the laser cavity.

The optical gain material may comprise a titanium-doped crystal.

The optical gain material may comprise a crystal doped with Ti³⁺ ions.

The optical gain material may comprise a Ti:sapphire crystal.

The optical gain material may comprise a chromium-doped crystal such as a Cr²⁺-doped crystal, a Cr³⁺-doped crystal or a Cr¹⁺-doped crystal.

The optical gain material may comprise a Cr²⁺-doped zinc chalcogenide such as Cr²⁺:ZnS and/or Cr²⁺:ZnSe.

The optical gain material may comprise Cr³⁺:BeAl₂O₄ (alexandrite).

The optical gain material may comprise a Cr³⁺-doped colquirirte such as LiSrAlF₆ LiSrGaFe₆, or LiCaAlF₆.

The optical gain material may comprise Cr⁴⁺:Mg₂SiO₄ (forsterite).

The optical gain material may comprise Cr⁴⁺:YAG

It should be understood that any one or more of the features of any one of the foregoing aspects of the present disclosure may be combined with any one or more or the features of any of the other foregoing aspects of the present disclosure.

### BRIEF DESCRIPTION OF THE DRAWINGS

Various single-frequency laser apparatus will now be described by way of non-limiting example only with reference to the following drawings of which:

FIG. 1A is a schematic of a single-frequency laser apparatus:

FIG. 1B is a schematic of part of the single-frequency laser apparatus of FIG. 1A;

FIG. 2 shows a transmission spectrum of a volume Bragg grating reflector (VBG) of the single-frequency laser apparatus of FIG. 1A;

FIG. 3 is a plot of optical output power as a function of the optical pump power which is coupled into an optical gain medium of the single-frequency laser apparatus of FIG. 1A;

FIG. 4 is a schematic of a first alternative optical cavity arrangement for use in the laser apparatus of FIG. 1A,

FIG. 5 is a schematic of a second alternative optical cavity arrangement for use in the laser apparatus of FIG. 1A;

FIG. 6 is a schematic of a third alternative optical cavity arrangement for use in the laser apparatus of FIG. 1A;

FIG. 7 is a schematic of a fourth alternative optical cavity arrangement for use in the laser apparatus of FIG. 1A;

FIG. 8 is a schematic of a filth alternative optical cavity arrangement for use in the laser apparatus of FIG. 1A;

FIG. 9 is a schematic of a sixth alternative optical cavity arrangement for use in the laser apparatus of FIG. 1A;

FIG. 10 is a schematic of an alternative optical pumping arrangement for use in the laser apparatus of FIG. 1A;

FIG. 11 is a plot of optical output power of the single-frequency laser apparatus of FIG. 1A as a function of the total optical pump power which is coupled into an optical gain medium of the single-frequency laser apparatus of FIG. 1A when using the alternative optical pumping arrangement of FIG. 10; and

FIG. 12 shows the optical power (lower trace and solid line) transmitted by an optical reference cavity of the single-frequency laser apparatus of FIG. 1A as an optical frequency of a peak in transmission of the optical reference cavity is scanned across the spectral bandwidth of an optical beam output from a laser cavity of the single-frequency laser apparatus of FIG. 1A when using the alternative optical pumping arrangement 780 shown in FIG. 10 and the ramp voltage (upper trace and dashed line) applied to the optical reference cavity to scan the optical frequency of the peak in transmission of the optical reference cavity.

### DETAILED DESCRIPTION OF THE DRAWINGS

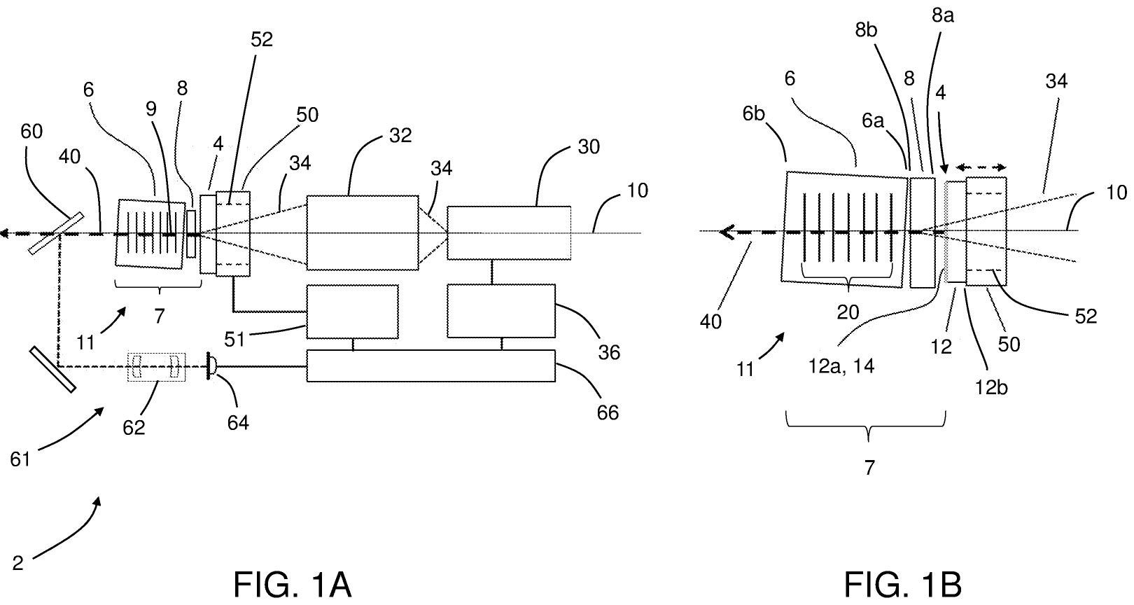

Referring initially to FIG. 1A, there is shown a single-frequency laser apparatus generally designated 2 including a mirror 4 and a volume Bragg grating (VBG) reflector 6 defining a simple Fabry-Perot type laser cavity generally designated 7 therebetween. The laser apparatus 2 further includes an optical gain medium 8 comprising an optical gain material in the form of a titanium-doped sapphire crystal (Ti:sapphire) for emitting and amplifying an intra-cavity beam 9 in a wavelength range of 650-1100 nm in the laser cavity 7. The mirror 4, the VBG reflector 6, and the optical gain medium 8 are arranged along an optical axis 10. The mirror 4 and the optical gain medium 8 are separated by a first air gap. The optical gain medium 8 and the VBG reflector 6 are separated by a second air gap. The mirror 4, the VBG reflector 6, and the optical gain medium 8 together constitute an optical cavity arrangement generally designated 11.

As will be described in more detail below, the mirror 4 is configured to be highly reflecting across at least part of a spectral gain bandwidth of the optical gain medium 8, whereas the VBG reflector 6 is configured to be partially reflecting across at least part of a spectral gain bandwidth of the optical gain medium 8 (approximately 1-10% transmission across at least part of a spectral gain bandwidth of the optical gain medium 8). In use, the mirror 4 serves as a high reflector for the laser apparatus 2 and the VBG reflector 6 serves as an output coupler for the laser apparatus 2.

FIG. 1B shows the optical cavity arrangement 11 in more detail. The optical gain medium 8 defines a first end surface 8a disposed towards the mirror 4 and an opposing second end surface 8b disposed towards the VBG reflector 6. Each of the first and second end surfaces 8a. 8b of the optical gain medium 8 has an anti-reflection (AR) coating which is configured to suppress optical reflections across at least part of a spectral gain bandwidth of the optical gain medium 8 and across a spectrum of the optical pump radiation.

The mirror 4 comprises a fused silica glass substrate 12 defining a planar front surface 12a disposed towards the optical gain medium 8 and an opposing planar rear surface 12b which is parallel to the front surface 12a. The mirror 4 further includes a multi-layer dielectric coating 14 disposed on the front surface 12a of the substrate 12, wherein the coating 14 is configured to be reflective across at least part of a spectral gain bandwidth of the optical gain medium 8.

The VBG reflector 6 is formed from a photo-thermo-refractive (PTR) glass and defines a refractive index variation 20 which varies periodically along a length of the VBG reflector 6. The VBG reflector 6 defines a planar front surface 6a disposed towards the optical gain medium 8 and an opposing planar rear surface 6b which is parallel to the front surface 6a. The VBG reflector 6 is oriented so that the front surface 6a defines a small non-zero angle relative to the second end surface 8b of the optical gain medium 8 In use, this relative orientation of the VBG reflector 6 serves to at least partially suppress multiple reflections between the front surface 6a of the VBG reflector 6 and the second end surface 8b of the optical gain medium 8. Each of the front and rear surfaces 6a, 6b of the VBG reflector 6 has an anti-reflection (AR) coating which is configured to suppress optical reflections across at least part of a spectral gain bandwidth of the optical gain medium 8.

Referring back to FIG. 1A, the laser apparatus 2 further includes an optical pump in the form of an indium gallium nitride (InGaN) pump laser diode 30 and one or more optical elements in the form of some beam reshaping optics 32 for coupling an optical pump beam 34 from the InGaN pump laser diode 30 to the optical gain medium 8 through the mirror 4 along the optical axis 10 so as to optically pump the optical gain medium 8. The multi-layer dielectric coating 14 of the mirror 4 is configured so as to transmit the optical pump beam 34. The rear surface 12b of the substrate 12 of the mirror 4 is also configured so as to transmit the optical pump beam 34. For example, the rear surface 12b of the substrate 12 of the mirror 4 may have an anti-reflection (AR) coating which is configured to suppress optical reflections at a wavelength of the optical pump beam 34 or across a wavelength range of the optical pump beam 34. The laser apparatus 2 further includes a laser diode controller 36 for driving and controlling an electrical current through the InGaN pump laser diode 30.

In use, the laser diode controller 36 drives an electrical current through the InGaN pump laser diode 30 causing the InGaN pump laser diode 30 to emit the optical pump beam 34 in a wavelength range from 450-530 nm. The beam reshaping optics 32 optically couple the optical pump beam 34 from the InGaN pump laser diode 30 to the optical gain medium 8 via the mirror 4 so as to optically pump the optical gain medium 8 and cause the optical gain medium 8 to emit and amplify the intra-cavity beam 9 in the laser cavity 7. A portion of the intra-cavity beam 9 is coupled out of the laser cavity 7 via the VBG reflector 6 to thereby form a laser output beam 40. Moreover, as will be explained in more detail below, the laser apparatus 2 is configured so that the laser output beam 40 has a single frequency.

To provide high enough absorption at a wavelength of the pump beam 34 and high enough optical gain at a wavelength of the intra-cavity beam 9 in the Ti:sapphire gain medium 8, the Ti:sapphire gain medium 8 should be doped to relatively high levels of approximately >0.25 wt. %. In contrast to rare-earth doped gain materials, however, heavy doping of a Ti:sapphire gain material leads to a degradation in an optical quality of the Ti:sapphire gain material. Usually the optical quality of any optical gain material is measured by a so-called figure-of-merit (FOM) parameter, which is defined as the ratio of a peak absorption coefficient at a peak absorption wavelength to an absorption coefficient at an emission wavelength. In the case of the Ti:sapphire gain medium 8, the FOM decreases with increasing doping levels from around a FOM of 500 (corresponding to a peak absorption coefficient of 1.5 cm⁻¹ at 514 nm and an absorption coefficient of 0.003 cm⁻¹ at an emission wavelength of 800 nm) to a FOM of 100 (corresponding to a peak absorption coefficient of 4.5 cm⁻¹ at 514 nm and an absorption coefficient of 0.045 cm⁻¹ at an emission wavelength of 800 nm). For efficient lasing operation of the laser apparatus 2, the Ti:sapphire gain medium 8 should have a FOM of approximately 150 or greater. In effect, this sets an upper limit on the doping level of the Ti:sapphire gain medium 8 and therefore a lower limit on the physical length of the Ti:sapphire gain medium 8 required to provide sufficient round-trip optical gain in the laser cavity 7 for efficient lasing operation of the laser apparatus 2. Furthermore, to provide a reasonably high absorption (>60%) at a wavelength in the optical pump beam 34 in the Ti:sapphire gain medium 8 when the physical length of the Ti:sapphire gain medium 8 is at least two mm's long, the wavelength of the optical pump beam 34 should be in the region of 450-530 nm and preferably within the range of 470-525 nm. Pumping at wavelengths longer than ˜470 nm reduces the pump-induced loss in the Ti:sapphire gain medium 8 and thus increases the laser efficiency.

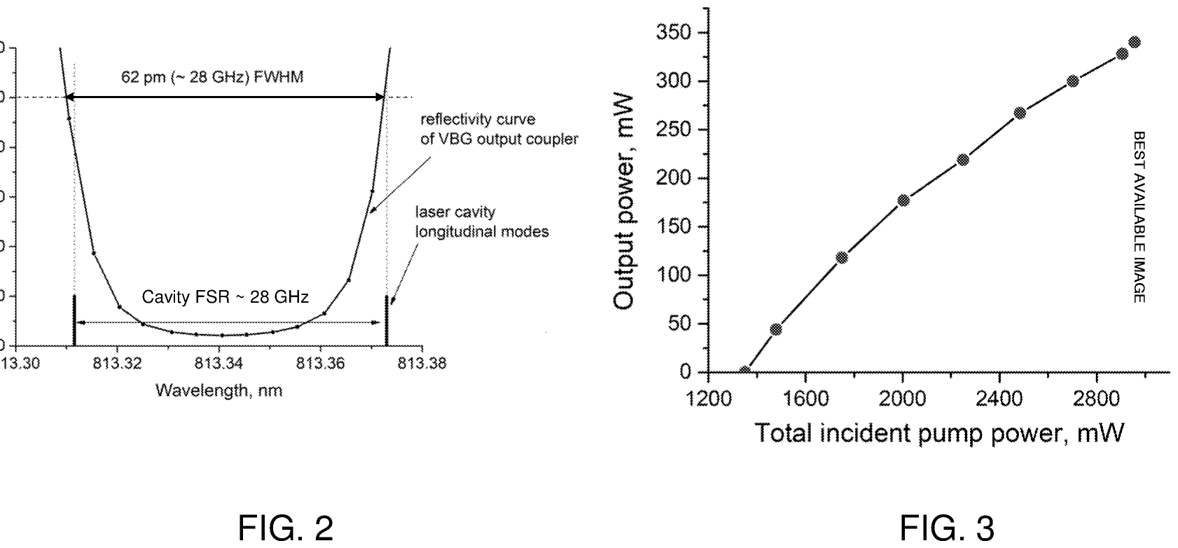

Referring now to FIG. 2, there is shown a transmission spectrum of the VBG reflector 6 having a reflectivity bandwidth of around 62 pm (or 28 GHz) full-width at halt maximum (FWHM) at a central wavelength of around 813.34 nm. For single mode operation of the laser apparatus 2 across the whole reflectivity bandwidth of the VBG reflector 6, the free spectral range (FSR) (i.e. the mode frequency separation) of the laser cavity 7 is around 28 GHz (assuming that an output coupling loss in the range of 40-50% is sufficient to suppress lasing operation of the laser apparatus 2). This corresponds to a single pass optical length of the laser cavity 7 of less than or equal to approximately 5.4 mm because the single pass optical length L of the laser cavity 7 is given by L=c/(2×FSR) where c represents the speed of light in a vacuum. The single pass optical length of the laser cavity 7 is given by the sum of: the single pass optical length of the Ti:sapphire gain medium 8: the effective single pass optical length of the VBG reflector 6: the length of the first air gap between the mirror 4 and the Ti:sapphire gain medium 8; and the length of the second air gap between the Ti:sapphire gain medium 8 and the VBG reflector 6. The effective optical length of the VBG reflector 6 is given by:

$${L}_{VBG} = {l}_{VBG} \frac{\sqrt{{R}_{max}}}{2 arc tanh \sqrt{{R}_{max}}}$$

where l_{VBG} is the physical length of VBG and Rₘₐₓ, is the VBG maximum reflectivity. If l_{VBG}=9 mm and Rₘₐₓ=0.978 (our experimental case) then the effective optical length of the VBG reflector 6 is 1.7 mm. Thus, to construct a laser cavity 7 having a single path optical length of 5.4 mm or less with first and second air gaps having a combined length of 1 mm, the physical length of the Ti:sapphire gain medium 8 should be approximately <2 mm. In other words, the requirement for single mode operation of the laser apparatus 2 across the whole reflectivity bandwidth of the VBG reflector 6 sets an upper limit of 2 mm on the physical length of the Ti:sapphire gain medium 8 for the specific VBG reflector 6 and the specific air gaps described above.

The laser apparatus 2 also includes a mirror actuator in the form of a generally annular PZT mirror actuator 50 and a piezo-controller 51. The rear surface 12b of the substrate 12 of the mirror 4 is attached, for example mounted or bonded, to the PZT mirror actuator 50. The PZT mirror actuator 50 defines an aperture 52 through which the optical pump beam 34 extends. As will be described in more detail below, the mirror actuator 50 is configured to move the mirror 4 along the optical axis 10.

The laser apparatus 2 includes an optical frequency reference system generally designated 61 which includes a partially reflecting mirror 60, a frequency-dependent optical transmission arrangement in the form of an optical reference cavity 62, and an optical detector 64. The laser apparatus 2 further includes a controller 66 which is configured for communication with the optical detector 64, the piezo-controller 51, and the laser diode controller 36. The optical reference cavity 62 has a frequency-dependent optical transmission spectrum which defines a frequency-dependent slope or gradient in optical transmission around the single frequency of the laser output beam 40. For example, the optical reference cavity 62 may have a frequency-dependent optical transmission spectrum which includes an optical transmission feature such as an optical transmission peak or fringe to one side of the single frequency of the laser output beam 40. The optical reference cavity 62 may for example be a Fabry-Perot cavity and/or a gas cell.

In use, the partially reflecting mirror 60 reflects a portion of the laser output beam 40 towards the optical reference cavity 62 and the optical detector 64 detects an optical beam transmitted by the optical reference cavity 62 and generates an electrical reference signal representative of an optical power of the optical beam transmitted by the optical reference cavity 62. The controller 66 receives the electrical reference signal and controls, vanes and/or modulates an electrical signal applied by the piezo-controller 51 to the PZT mirror actuator 50 according to the electrical reference signal so as to stabilise the frequency of the laser output beam 40 i.e. so as to narrow a linewidth of the single frequency laser output beam 40. Additionally or alternatively, the controller 66 controls, varies and/or modulates the electrical current which the laser diode controller 36 drives through the InGaN pump laser diode 30 according to the electrical reference signal so as to stabilise the frequency of the laser output beam 40.

In this way, the optical transmission of the optical reference cavity 62 may be used to detect frequency changes in the single frequency laser output beam 40. In effect, when a frequency of the single frequency laser output beam 40 lies on a slope of a peak in the optical transmission spectrum of the optical reference cavity 62, the optical reference cavity 62 translates a frequency change in the single frequency laser output beam 40 into a change in intensity of the optical beam transmitted by the optical reference cavity 62. The optical detector 64 detects this frequency-dependent intensity and converts this into the frequency-dependent electrical reference signal. Specifically, the optical detector 64 detects the frequency-dependent intensity and converts this into a frequency-dependent output voltage which can be used for comparison with a reference voltage at the controller 66. As the frequency of the laser output beam 40 lies on a slope of a peak in the optical transmission spectrum of the optical reference cavity 62, the laser frequency can thus be locked “side-of-fringe” to the transmission of the optical reference cavity 62 to thereby stabilise the frequency (i.e. to narrow the linewidth) of the laser output beam 40.

The controller 66 may be configured to control, vary and/or modulate the electrical signal applied by the piezo-controller 51 to the PZT mirror actuator 50 so as to tune the frequency of the laser output beam 40 independently of the electrical reference signal to enable tuning of the frequency of the laser output beam 40 over a wider range of frequencies. Additionally or alternatively, the controller 66 may be configured to control, vary and/or modulate the electrical current which the laser diode controller 36 drives through the InGaN pump laser diode 30 independently of the electrical reference signal to enable tuning of the frequency of the laser output beam 40 over a wider range of frequencies. Additionally or alternatively, the laser apparatus 2 may include a heater (not shown) for heating the VBG reflector 6 and/or the Ti:sapphire gain medium 8, and the controller 66 may be configured to control, vary and/or modulate the heater independently of the electrical reference signal to enable tuning of the frequency of the laser output beam 40 over a wider range of frequencies. Additionally or alternatively, the laser apparatus 2 may include a cooler (not shown) for cooling the VBG reflector 6 and/or the optical gain medium 8, and the controller 66 may be configured to control, vary and/or modulate the cooler independently of the electrical reference signal to enable tuning of the frequency of the laser output beam 40 over a wider range of frequencies. Temperature tuning the VBG reflector 6 and/or the optical gain medium 8 in this way may provide the laser apparatus 2 with a tuning range of up to 100 μm with a typical tuning ratio of 7 pm/C.

Referring now to FIG. 3, there is shown a plot of the optical power of the single-frequency laser output beam 40 as a function of the optical power of the pump beam 34 which is coupled into the optical gain medium 8 for an optical pump wavelength of 470 nm.

From the foregoing description, one of ordinary skill in the art will understand that the laser apparatus 2 provides a robust, compact, low cost, high-power wavelength adjustable (from approximately 650 to 950 nm), narrow linewidth (<100 kHz), single frequency laser source which is suitable for a wide range of applications from laser sensing, spectroscopy, and high precision frequency metrology sectors.

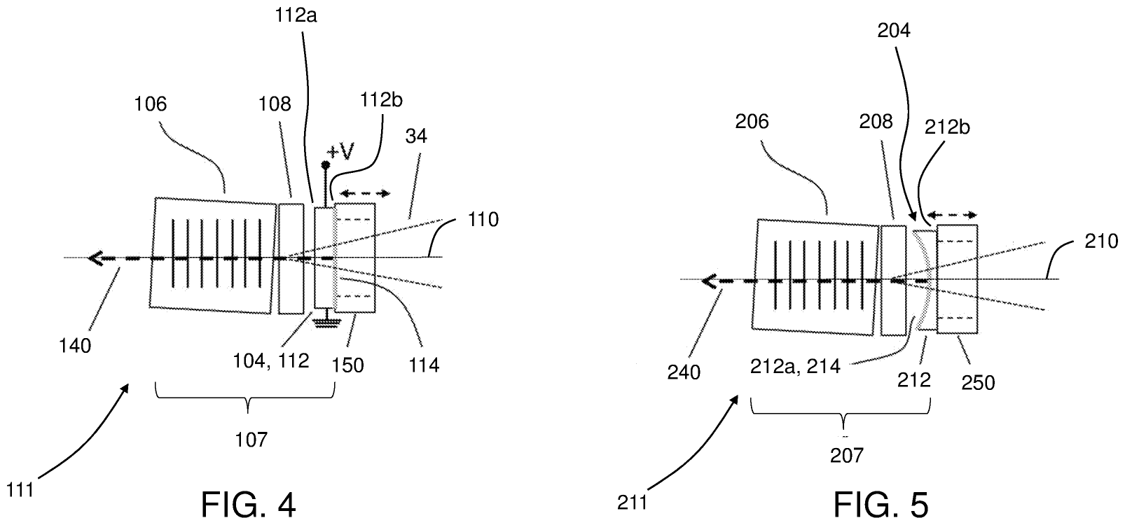

Referring now to FIG. 4, there is shown a first alternative optical cavity arrangement 111 which may be used in the laser apparatus 2 of FIG. 1A instead of the optical cavity arrangement 11. Features of the first alternative optical cavity arrangement 111 of FIG. 4 are identified with reference numerals which are incremented by 100 relative to the reference numerals used to identify like features of the optical cavity arrangement 11 of FIGS. 1A and 1B. Specifically, the optical cavity arrangement 111 includes a mirror 104 and a volume Bragg grating (VBG) reflector 106 defining a simple Fabry-Perot type laser cavity generally designated 107 therebetween. The optical cavity arrangement 111 further includes a Ti:sapphire optical gain medium 108 for emitting and amplifying an intra-cavity beam in a wavelength range of 650-950 nm in the laser cavity 107. The mirror 104, the VBG reflector 106, and the optical gain medium 108 are arranged along an optical axis 110. The mirror 104 and the optical gain medium 108 are separated by a first air gap. The optical gain medium 108 and the VBG reflector 106 are separated by a second air gap.

The mirror 104 comprises a substrate 112 defining a planar front surface 112a disposed towards the optical gain medium 108 and an opposing planar rear surface 112b which is parallel to the front surface 112a. However, unlike the mirror 4 of the optical cavity arrangement 11 of FIGS. 1A and 1B, the substrate 112 of the mirror 104 is formed from an electro-optic material in the form of MgO:LiNbO₃. Moreover, the mirror 104 further includes a multi-layer dielectric coating 114 disposed on the rear surface 112b of the substrate 112, wherein the coating 114 is configured to be reflective across at least part of a spectral gain bandwidth of the optical gain medium 108. One of ordinary skill in the art will understand that as a consequence of the arrangement of the multilayer dielectric coating on them for on the rear surface 112b of the substrate 112, the MgO:LiNbO₃ electro-optic material is located within the laser cavity 107. The mirror 104 is attached, for example mounted or bonded, to a generally annular PZT mirror actuator 150

In use, the optical pump beam 34 is used to optically pump optical gain medium 108 and a voltage is applied to the MgO:LiNbO₃ electro-optic material of the substrate 112 and controlled by the controller 66 so as to vary refractive index of the MgO:LoNbO₃ electro-optic material according to the electrical reference signal generated by the optical detector 64 so as to stabilise the frequency of a laser output beam 140 i.e. so as to narrow a linewidth of the single frequency laser output beam 140. Applying a voltage to such an electro-optic material enables faster laser frequency control (bandwidth up to few 100 kHz) compared with the laser frequency control obtainable using the PZT mirror actuator 150 (up to about 10 kHz only). Additionally or alternatively, the controller 66 may be configured to control the voltage applied to the MgO:LiNbO₃ electro-optic material of the substrate 112 so as to tune the frequency of the laser output beam 140 independently of the electrical reference signal generated by the optical detector 64 to enable tuning of the frequency of the laser output beam 140 over a wider range of frequencies.

Referring now to FIG. 5, there is shown a second alternative optical cavity arrangement 211 which may be used in the laser apparatus 2 of FIG. 1A instead of the optical cavity arrangement 11. Features of the second alternative optical cavity arrangement 211 of FIG. 5 are identified with reference numerals which are incremented by “200” relative to the reference numerals used to identify like features of the optical cavity arrangement 11 of FIGS. 1A and 1B. Specifically, the optical cavity arrangement 211 includes a mirror 204 and a volume Bragg grating (VBG) reflector 206 defining a simple Fabry-Perot type laser cavity generally designated 207 therebetween. The optical cavity arrangement 211 further includes a Ti:sapphire optical gain medium 208 for emitting and amplifying an intra-cavity beam in a wavelength range of 650-950 nm in the laser cavity 207. The mirror 204, the VBG reflector 206, and the optical gain medium 208 are arranged along an optical axis 210. The mirror 204 and the optical gain medium 208 are separated by a first air gap. The optical gain medium 208 and the VBG reflector 206 are separated by a second air gap.

Like the mirror 4 of the optical cavity arrangement 11 of FIGS. 1A and 1B, the mirror 204 comprises a fused silica glass substrate 212. However, unlike the mirror 4 of the optical cavity arrangement 11 of FIGS. 1A and 1B, the substrate 212 defines a curved front surface 212a disposed towards the optical gain medium 208. The substrate 212 further defines a planar rear surface 212b. The mirror 204 further includes a multi-layer dielectric coating 214 disposed on the curved front surface 212a of the substrate 212, wherein the coating 214 is configured to be reflective across at least part of a spectral gain bandwidth of the optical gain medium 208. The mirror 204 is attached, for example mounted or bonded, to a generally annular PZT mirror actuator 250. One of ordinary skill in the art will understand that the optical cavity arrangement 211 of FIG. 5 operates in a similar fashion to the optical cavity arrangement 11 of FIGS. 1A and 1B.

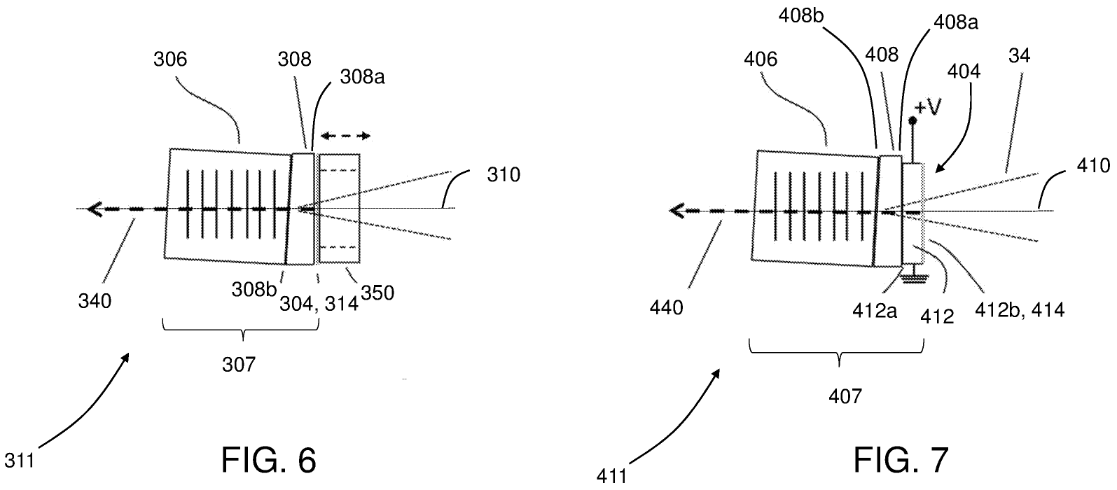

Referring now to FIG. 6, there is shown a third alternative optical cavity arrangement 311 which may be used in the laser apparatus 2 of FIG. 1A instead of the optical cavity arrangement 11. Features of the third alternative optical cavity arrangement 311 of FIG. 6 are identified with reference numerals which are incremented by “300” relative to the reference numerals used to identify like features of the optical cavity arrangement 11 of FIGS. 1A and 1B. Specifically, the optical cavity arrangement 311 includes a mirror 304 and a volume Bragg grating (VBG) reflector 306 defining a simple Fabry-Perot type laser cavity generally designated 307 therebetween. The optical cavity arrangement 311 further includes a Ti:sapphire optical gain medium 308 for emitting and amplifying an intra-cavity beam in a wavelength range of 650-1100 nm in the laser cavity 307. The mirror 304, the VBG reflector 306, and the optical gain medium 308 are arranged along an optical axis 310.

However, unlike the Ti:sapphire optical gain medium 8 of the optical cavity arrangement 11 of FIGS. 1A and 1B which has parallel end surfaces, the Ti:sapphire optical gain medium 308 has first and second non-parallel end surfaces 308a and 308b. Also, unlike the optical cavity arrangement 11 of FIGS. 1A and 1B, the mirror 304 and the optical gain medium 308 are not separated by an air gap. Instead, the mirror 304 takes the form of a multi-layer dielectric coating 314 which is deposited or formed directly on the first end surface 308a of the optical gain medium 308. Furthermore, unlike the optical cavity arrangement 11 of FIGS. 1A and 1B, the optical gain medium 308 and the VBG reflector 306 are attached or bonded to one another at the second end surface 308b of the optical gain medium 308 so that the mirror 304, the optical gain medium 308, and the VBG reflector 306 together define a unitary composite optical cavity arrangement 311. For example, the optical gain medium 308 and the VBG reflector 306 may be capillary bonded to one another at the second end surface 308b of the optical gain medium 308. The optical gain medium 308 is attached, for example mounted or bonded, to a generally annular PZT mirror actuator 350.

One of ordinary skill in the art will understand that the unitary composite optical cavity arrangement 311 of FIG. 6 is more compact and more robust than the optical cavity arrangement 11 of FIGS. 1A and 1B. In particular, the unitary composite optical cavity arrangement 311 of FIG. 6 has a shorter optical length compared with the optical cavity arrangement 11 of FIGS. 1A and 1B such that the optical frequency separation between longitudinal modes of the composite optical cavity arrangement 311 of FIG. 6 is greater than the optical frequency separation between longitudinal modes of the composite optical cavity arrangement 11 of FIGS. 1A and 1B Use of the composite optical cavity arrangement 311 of FIG. 6 may relax the FWHM reflectivity spectral bandwidth requirements of the VBG reflector 306 i.e. use of the composite optical cavity arrangement 311 of FIG. 6 may allow the use of a VBG reflector 306 with a FWHM reflectivity spectral bandwidth greater than 60 μm whilst still maintaining single frequency operation of the laser apparatus 2. For example, use of the composite optical cavity arrangement 311 of FIG. 6 may allow the use of a VBG reflector 306 with a FWHM reflectivity spectral bandwidth of up to 50 GHz whilst still maintaining single frequency operation of the laser apparatus 2. In other respects, one of ordinary skill in the art will understand that the optical cavity arrangement 311 of FIG. 6 operates in a similar fashion to the optical cavity arrangement 11 of FIGS. 1A and 1B.

Referring now to FIG. 7, there is shown a fourth alternative optical cavity arrangement 411 which may be used in the laser apparatus 2 of FIG. 1A instead of the optical cavity arrangement 11. Features of the fourth alternative optical cavity arrangement 411 of FIG. 7 are identified with reference numerals which are incremented by “400” relative to the reference numerals used to identify like features of the optical cavity arrangement 11 of FIGS. 1A and 1B. Specifically, the optical cavity arrangement 411 includes a mirror 404 and a volume Bragg grating (VBG) reflector 406 defining a simple Fabry-Perot type laser cavity generally designated 407 therebetween. The optical cavity arrangement 411 further includes a Ti:sapphire optical gain medium 408 for emitting and amplifying an intra-cavity beam in a wavelength range of 650-950 nm in the laser cavity 407. The mirror 404, the VBG reflector 406, and the optical gain medium 408 are arranged along an optical axis 410. However, unlike the Ti:sapphire optical gain medium 8 of the optical cavity arrangement 11 of FIGS. 1A and 1B which has parallel end surfaces, the Ti:sapphire optical gain medium 408 has first and second non-parallel end surfaces 408a and 408b.

Furthermore, the mirror 404 comprises a substrate 412 defining a planar front surface 412a disposed towards the optical gain medium 408 and an opposing planar rear surface 412b which is parallel to the front surface 412a. However, unlike the mirror 4 of the optical cavity arrangement 11 of FIGS. 1A and 1B, the substrate 412 of the mirror 404 is formed from an electro-optic material in the form of MgO:LiNbO₃. Moreover, the mirror 404 further includes a multi-layer dielectric coating 414 disposed on the rear surface 412b of the substrate 412, wherein the coating 414 is configured to be reflective across at least part of a spectral gain bandwidth of the optical gain medium 408. One of ordinary skill in the art will understand that as a consequence of the arrangement of the multilayer dielectric coating on them for on the rear surface 412b of the substrate 412, the MgO:LiNbO₃ electro-optic material is located within the laser cavity 407.

Also, unlike the optical cavity arrangement 11 of FIGS. 1A and 1B, the mirror 404 and the optical gain medium 408 are not separated by an air gap. Instead, the mirror 404 and the optical gain medium 408 are attached or bonded to one another at the first end surface 408a of the optical gain medium 408. For example, the mirror 404 and the optical gain medium 408 may be capillary bonded to one another at the first end surface 408a of the optical gain medium 408. Furthermore, unlike the optical cavity arrangement 11 of FIGS. 1A and 1B, the optical gain medium 408 and the VBG reflector 406 are attached or bonded to one another at a second end surface 408b of the optical gain medium 408 so that the mirror 404, the optical gain medium 408, and the VBG reflector 406 together define a unitary composite optical cavity arrangement 411. For example, the optical gain medium 408 and the VBG reflector 406 may be capillary bonded to one another at the second end surface 408b of the optical gain medium 408.

In use, the optical pump beam 34 is used to optically pump optical gain medium 408 and a voltage is applied to the MgO:LiNbO₃ electro-optic material of the substrate 412 and controlled by the controller 66 so as to vary refractive index of the MgO:LiNbO₃ electro-optic material according to the electrical reference signal generated by the optical detector 64 so as to stabilise the frequency of a laser output beam 440 i.e. so as to narrow a linewidth of the single frequency laser output beam 440. Applying a voltage to such an electro-optic material enables faster laser frequency control (bandwidth up to few 100 kHz) compared with the laser frequency control obtainable using the PZT mirror actuator 150 tip to about 10 kHz only). Additionally or alternatively, the controller 66 may be configured to control the voltage applied to the MgO:LiNbO₃ electro-optic material of the substrate 412 so as to tune the frequency of the laser output beam 440 independently of the electrical reference signal generated by the optical detector 64 to enable tuning of the frequency of the laser output beam 440 over a wider range of frequencies.

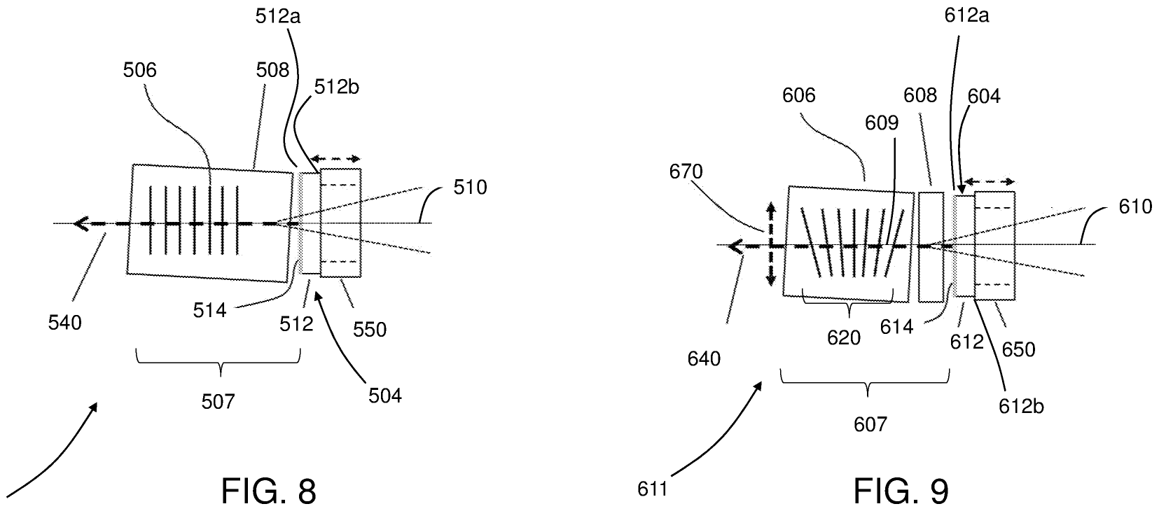

Referring now to FIG. 8, there is shown a fifth alternative optical cavity arrangement 511 which may be used in the laser apparatus 2 of FIG. 1A instead of the optical cavity arrangement 11. Features of the fifth alternative optical cavity arrangement 511 of FIG. 8 are identified with reference numerals which are incremented by “500” relative to the reference numerals used to identify like features of the optical cavity arrangement 11 of FIGS. 1A and 1B. Specifically, the optical cavity arrangement 511 includes a mirror 504 and a volume Bragg grating (VBG) reflector 506 defining a simple Fabry-Perot type laser cavity generally designated 507 therebetween. The optical cavity arrangement 511 also includes a Ti:sapphire optical gain medium 508 for emitting and amplifying an intra-cavity beam in a wavelength range of 650-950 nm in the laser cavity 507. However, unlike the optical cavity arrangement 11 of FIGS. 1A and 1B, the volume Bragg grating (VBG) reflector 506 is defined in the material of the optical gain medium 508. The mirror 504, the VBG reflector 506, and the optical gain medium 508 are arranged along an optical axis 510. The mirror 504 and the optical gain medium 508 are separated by an air gap.

Like the mirror 4 of the optical cavity arrangement 11 of FIGS. 1A and 1B, the mirror 504 comprises a fused silica glass substrate 512 which defines a planar front surface 512a disposed towards the optical gain medium 508. The substrate 512 further defines a planar rear surface 512b. The mirror 504 further includes a multi-layer dielectric coating 514 disposed on the front surface 512a of the substrate 512, wherein the coating 514 is configured to be reflective across at least part of a spectral gain bandwidth of the optical gain medium 508. The mirror 504 is attached, for example mounted or bonded, to a generally annular PZT mirror actuator 550. One of ordinary skill in the art will understand that the optical cavity arrangement 511 of FIG. 8 operates in a similar fashion to the optical cavity arrangement 11 of FIGS. 1A and 1B.

Referring now to FIG. 9, there is shown a sixth alternative optical cavity arrangement 611 which may be used in the laser apparatus 2 of FIG. 1A instead of the optical cavity arrangement 11. Features of the sixth alternative optical cavity arrangement 611 of FIG. 9 are identified with reference numerals which are incremented by “600” relative to the reference numerals used to identify like features of the optical cavity arrangement 11 of FIGS. 1A and 1B. Specifically, the optical cavity arrangement 611 includes a mirror 604 and a volume Bragg grating (VBG) reflector 606 defining a simple Fabry-Perot type laser cavity generally designated 607 therebetween. The optical cavity arrangement 611 further includes a Ti:sapphire optical gain medium 608 for emitting and amplifying an intra-cavity beam in a wavelength range of 650-950 nm in the laser cavity 607. The mirror 604, the VBG reflector 606, and the optical gain medium 608 are arranged along an optical axis 610. The mirror 604 and the optical gain medium 608 are separated by a first air gap. The optical gain medium 608 and the VBG reflector 606 are separated by a second air gap.

Like the mirror 4 of the optical cavity arrangement 11 of FIGS. 1A and 1B, the mirror 604 comprises a fused silica glass substrate 612 which defines a planar front surface 612a disposed towards the optical gain medium 608 and a planar rear surface 612b. The mirror 604 further includes a multi-layer dielectric coating 614 disposed on the front surface 612a of the substrate 612, wherein the coating 614 is configured to be reflective across at least part of a spectral gain bandwidth of the optical gain medium 608. The mirror 604 is attached, for example mounted or bonded, to a generally annular PZT mirror actuator 650.

However, unlike the VBG reflector 6 of the optical cavity arrangement 11 of FIGS. 1A and 1B, the VBG reflector 606 defines a refractive index profile 620 which varies periodically along the length of the VBG reflector 606, wherein a period of the refractive index profile 620 is different at different lateral positions across the VBG reflector 606. More specifically, the VBG reflector 606 defines a refractive index profile 620 which varies periodically along the length of the VBG reflector 606 with a period which varies or fans-out according to a lateral position across the VBG reflector 606. Moreover, the VBG reflector 606 is moveable laterally relative to the optical axis 610. For example, the laser apparatus 2 may comprise a VBG reflector actuator (not shown) for this purpose and the controller 66 may be configured to control the VBG reflector actuator so as to vary the lateral position of the VBG reflector 606 relative to the optical axis 610 as indicated by the dashed line 670 in FIG. 9 so that an intra-cavity beam 609 is subjected to, or experiences, a periodic refractive index variation with a different period according to the lateral position of the VBG reflector 606 relative to the optical axis 610 independently of the electrical reference signal generated by the optical detector 64 to thereby enable tuning of the frequency of a laser output beam 640 over a wider range of frequencies. One of ordinary skill in the art will understand that, in other respects, the optical cavity arrangement 611 of FIG. 9 operates in a similar fashion to the optical cavity arrangement 11 of FIGS. 1A and 1B.

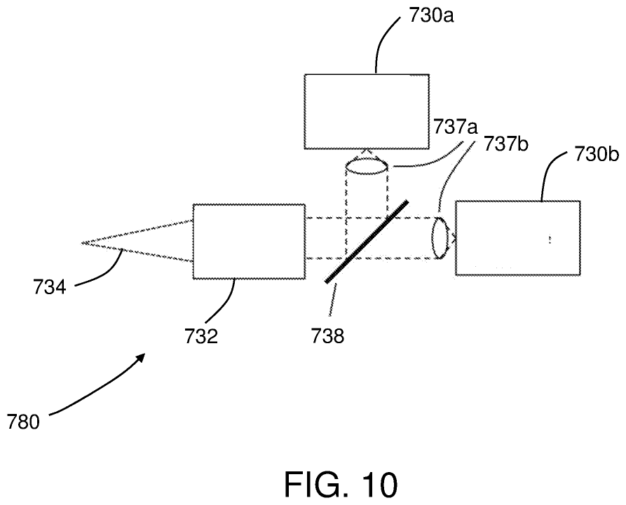

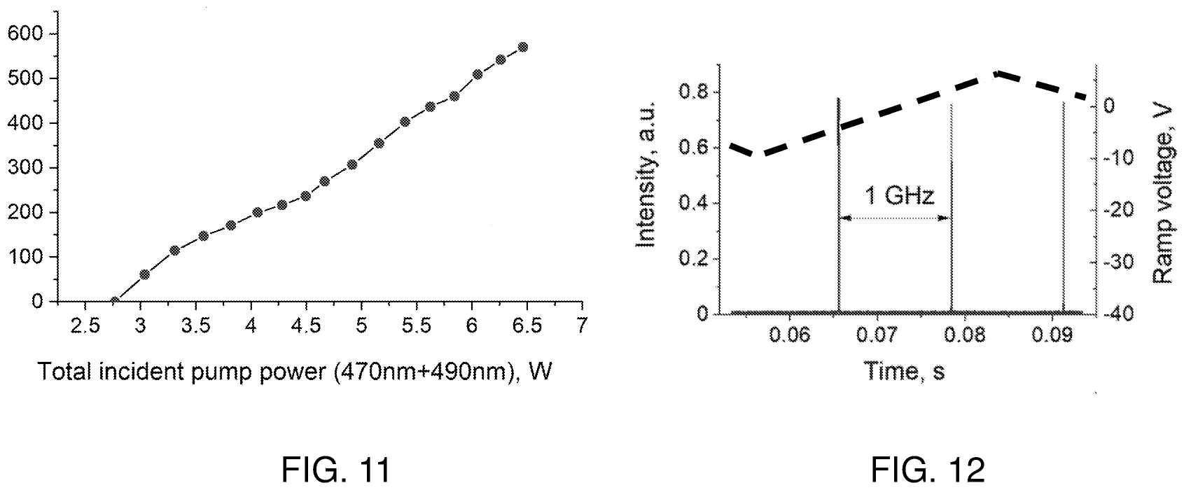

FIG. 10 shows an alternative optical pumping arrangement generally designated 780 which may be used in the laser apparatus 2 of FIG. 1A instead of the InGaN pump laser diode 30 and the beam reshaping optics 32. It should be further understood that the alternative optical pumping arrangement 780 may be used to generate an optical pump beam 734 for optically pumping any of the optical gain media of any of the optical cavity arrangements shown in FIG. 1A. FIG. 1B, and FIGS. 4-9. The alternative optical pumping arrangement 780 includes a first InGaN laser diode 730a, a second InGaN laser diode 730b, a first collimating lens 737a for collimating a first optical pump beam emitted from the first InGaN laser diode 730a, a second collimating lens 737b for collimating a second optical pump beam emitted from the second InGaN laser diode 730b, a dichroic mirror 738 for combining the first and second optical pump beams, and one or more optical elements in the form of one or more beam-shaping optics 732 for optically coupling the combined optical pump beam 734 to any of the optical gain media of any of the optical cavity arrangements shown in any of FIG. 1A. FIG. 1B, and FIGS. 4-9. One of the first and second InGaN laser diodes 730a, 730b is configured to emit light at a wavelength in the range from 450 nm to 480 nm and the other one of the first and second InGaN laser diodes 730a, 730b is configured to emit light at a wavelength in the range from 480 nm to 530 nm. The dichroic mirror 738 is configured to reflect light at a wavelength in the range from 450 nm to 480 nm and to transmit light at a wavelength in the range from 480 nm to 530 nm or to transmit light at a wavelength in the range from 450 nm to 480 nm and to reflect light at a wavelength in the range from 480 nm to 530 nm, so as to combine the first and second optical pump beams emitted by the first and second InGaN laser diodes 730a, 730b. The optical power of the combined optical pump beam 734 may be greater than the optical power than the optical pump beam 34 generated by the InGaN pump laser diode 30 shown in FIG. 1A. When combined with the use of one optical pump beam at a wavelength in the range from 450 nm to 480 close to the peak in the absorption of any of the Ti:sapphire optical gain media shown in FIG. 1A, FIG. 1B, and FIGS. 4-9 and the use of another optical pump beam at a wavelength in the range from 480 nm to 530 nm which is also close to the peak in the absorption of any of the Ti:sapphire optical gain media shown in any of FIG. 1A, FIG. 1B, and FIGS. 4-9, the alternative optical pumping arrangement 780 may enable any of the Ti:sapphire optical gain media shown in any of FIG. 1A, FIG. 1B, and FIGS. 4-9 to generate a higher level of optical gain when compared with the use of the InGaN pump laser diode 30 shown in FIG. 1A. For example, referring to FIG. 11, there is shown a plot of the optical power of the single-frequency laser output beam 40 generated as a function of the total optical power of the combined optical pump beam 734 which is coupled into the optical gain medium 8 for first and second InGaN laser diodes 730a. 730b having optical pump wavelengths of 470 nm and 490 nm when using the alternative optical pumping arrangement 780 shown in FIG. 10 is used in place of the InGaN pump laser diode 30 in the single-frequency laser apparatus 2 of FIG. 1A. The lower trace (solid line) shown in FIG. 12 is the optical power detected by the optical detector 64 when the optical frequency of the peak in transmission of the optical reference cavity 62 is scanned across the spectral bandwidth of the laser output beam 40 when using the alternative optical pumping arrangement 780 shown in FIG. 10. The upper trace (dashed line) shown in FIG. 12 is the ramp voltage applied to the optical reference cavity 62 to scan the optical frequency of the peak in transmission of the optical reference cavity 62. Specifically, the lower trace shows two peaks separated by the 1 GHz free spectral range of the optical reference cavity 62 as the voltage applied to the optical reference cavity 62 is increased. As will be understood by one of ordinary skill in the art, the absence of any additional peaks between the two peaks of the lower trace of FIG. 12 indicates single longitudinal-mode or single-frequency operation of the laser apparatus 2. Single longitudinal-mode operation of the laser apparatus 2 was maintained throughout the entire range of the laser output powers shown in FIG. 11. From the foregoing description, one of ordinary skill in the art will understand that the laser apparatus 2 provides a robust, compact, low cost, high-power wavelength adjustable (from approximately 650 to 950 nm), narrow linewidth (<100 kHz), single frequency laser source which is suitable for a wide range of applications from laser sensing, spectroscopy, and high precision frequency metrology sectors.

Various modifications are possible to the apparatus and methods described above. For example, although all of the optical gain media described above with reference to FIG. 1A. FIG. 1B, and FIGS. 4-9 are described as being formed from, or including, a Ti:sapphire optical gain material, the optical gain material may be formed from, or include, a transition-metal doped crystal of a different type, and the pump wavelength, the physical length and doping level of the optical gain material may be selected so as to provide sufficient optical gain in the laser cavity to overcome optical losses in the laser cavity. For example, the optical gain material may comprise a crystal of any kind doped with titanium ions such as Ti³⁺ ions. The optical gain material may comprise a chromium-doped crystal such as a Cr²⁺-doped crystal, a Cr³⁺-doped crystal or a Cr¹⁺-doped crystal. The optical gain material may comprise a Cr²⁺-doped zinc chalcogenide such as Cr²⁺:ZnS and/or Cr²⁺:ZnSe. The optical gain material may comprise Cr³⁺:BeAl₂O₄ (alexandrite). The optical gain material may comprise a Cr³⁺-doped colquiriite such as LiSrAlF₆, LiSrGaF₆, and/or LiCaAlF₆. The optical gain material may comprise Cr⁴⁺:Mg:SiO₄ (forsterite) or Cr⁴⁺:YAG. The reflectivity spectral bandwidth of the VBG reflector and the single pass optical length of the laser cavity may be adjusted according to at least one of the type, physical length, and doping level of the optical gain material.

Although the physical length of the Ti:sapphire optical gain medium 8 was described as being approximately 2 mm long for first and second air gaps having a combined length of 1 mm, it is possible to use optical gain media of different physical lengths whilst still maintaining single-frequency operation of the laser apparatus depending on the FHWM reflectivity bandwidth of the VBG reflector used. For example, when using the VBG reflector 6 having the FHWM reflectivity bandwidth shown in FIG. 2 in combination with one of the unitary composite optical cavity arrangements 311 and 411 of FIGS. 6 and 7 respectively, the physical length of the Ti:sapphire gain medium may be in the range of 0.5 mm to 7 mm whilst still maintaining single frequency operation of the laser apparatus.

The beam reshaping optics 32 and 732 may comprise at least one of an aspheric lens, a cylindrical lens, and a spherical lens. Instead of, or in addition to, using beam reshaping optics 32. 732 to couple an optical pump beam 34. 734 into any of the optical gain media of any of the optical cavity arrangements shown in FIG. 1A. FIG. 1B, and FIGS. 4-9, an optical fibre such as a multi-mode optical fibre may be used to couple an optical pump power into any of the optical gain media of any of the optical cavity arrangements shown in FIG. 1A. FIG. 1B, and FIGS. 4-9.

Other frequency stabilisation techniques such as “top-of-fringe” frequency stabilisation or Pound-Drever-Hall frequency stabilisation may be used instead of the “side-of-fringe” frequency stabilisation technique described with reference to FIG. 1A.

In addition to, or instead of, the optical frequency reference system 61 of FIG.

IA, the laser apparatus may include an optical frequency reference system which comprises a frequency-stabilised optical reference source such as a single-mode frequency-stabilised optical reference source or a frequency-stabilised optical frequency comb. The optical frequency reference system may further comprise an optical detector, and one or more output optical elements for optically coupling at least a portion of an output beam emitted from the laser cavity to the optical detector and or optically coupling at least a portion of an output beam emitted from the frequency-stabilised optical reference source to the optical detector so as to generate an electrical reference signal representative of a frequency difference between a frequency of the output beam emitted from the laser apparatus and a frequency of the output beam emitted from the frequency-stabilised optical reference source. One of ordinary skill in the art will understand that the generated electrical reference signal may have a beat frequency equal in value to the difference between the frequency of the output beam emitted from the laser cavity and the frequency of the output beam emitted from the frequency-stabilised optical reference source.

One of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above. For example, the VBG reflector may be defined by the optical gain material like in the optical cavity arrangement 511 of FIG. 8, but the mirror may be curved, the mirror may be formed on a first end surface of the optical gain material, or the mirror may include a substrate which is formed from an electro-optic material such as MgO:LiNbO3.

The VBG reflector may define a refractive index profile which varies periodically along the length of the VBG reflector with a period which varies, for example fans-out, according to a lateral position across the VBG reflector like in the optical cavity arrangement 611 of FIG. 9, but the VBG reflector may be used in any of the optical cavity arrangements of FIGS. 1A, 1B and 4 to 8.

1. A single-frequency laser apparatus, comprising:
a mirror and a volume Bragg grating (VBG) reflector defining a laser cavity therebetween; and
an optical gain material for emitting and amplifying an intra-cavity beam in the laser cavity,
wherein the optical gain material comprises a transition-metal doped crystal such as a crystal doped with transition-metal ions selected from one or more of Ti³⁺ ions, Cr²⁺ ions, Cr³⁺ ions or Cr⁴⁺ ions.

2. A single-frequency laser apparatus according to claim 1, wherein a reflectivity spectrum of the VBG reflector and an optical length of the laser cavity are selected so that a beam output from the laser cavity is a single-frequency output beam or includes only one longitudinal mode of the laser cavity, for example wherein the VBG reflector has a reflectivity spectrum which has a full-width half maximum reflectivity spectral bandwidth which is comparable to, equal to, or less than, a free spectral range (FSR) of the laser cavity.

3. A single-frequency laser apparatus according to claim 1, wherein the VBG reflector has a reflectivity spectrum which has a full-width half maximum reflectivity spectral bandwidth in the range of 10 GHz to 50 GHz, 15 GHz to 40 GHz, or 20 GHz to 30 GHz.

4. A single-frequency laser apparatus according to claim 1, wherein the laser cavity has a single pass optical length in the range of 3 mm to 15 mm, 4 mm to 10 mm, or 5 mm to 7.5 mm.

5. A single-frequency laser apparatus according to claim 1, wherein the laser cavity is at least one of a Fabry-Perot laser cavity, a linear laser cavity, or a standing-wave laser cavity.

6. A single-frequency laser apparatus according to claim 1, comprising an optical gain medium, wherein the optical gain medium comprises the optical gain material, and wherein there are no optical components located between the optical gain medium and the mirror and/or there are no optical components located between the optical gain medium and the VBG reflector.

7. A single-frequency laser apparatus according to claim 6, wherein the optical gain medium and the mirror are separated by a gap or the optical gain medium and the mirror are separated by a material which bonds the optical gain medium and the mirror together; and/or
wherein the optical gain medium and the VBG reflector are separated by a gap or the optical gain medium and the VBG reflector are separated by a material which bonds the optical gain medium and the VBG reflector together.

8. A single-frequency laser apparatus according to claim 6, wherein a physical length of the optical gain medium is in the range of 0.5 mm to 7 mm, 1 mm to 4.5 mm, or 1.5 mm to 3 mm.

9. A single-frequency laser apparatus according to claim 6, wherein the optical gain medium comprises one or more coatings applied to, or formed on, the optical gain material.

10. A single-frequency laser apparatus according to claim 6, wherein the optical gain medium is separated from the mirror by a first gap and the optical gain medium is separated from the VBG reflector by a second gap.

11. A single-frequency laser apparatus according to claim 6, wherein the mirror and the optical gain medium together define a unitary composite mirror/optical gain component which is separated from the VBG reflector by a gap and, optionally, wherein the mirror is attached, for example bonded, to a first end surface of the optical gain medium.

12. A single-frequency laser apparatus according to claim 6, wherein the optical gain medium and the VBG reflector together define a unitary composite VBG reflector/optical gain component which is separated from the mirror by a gap and, optionally, wherein a front surface of the VBG reflector is attached, for example bonded, to a second end surface of the optical gain material.

13. A single-frequency laser apparatus according to claim 6, wherein the mirror, the optical gain medium, and the VBG reflector together define a unitary composite cavity arrangement.

14. A single-frequency laser apparatus according to claim 6, wherein the VBG reflector comprises a VBG reflector body member, wherein a periodic refractive index profile, variation or modulation extends through the VBG reflector body member and, optionally, wherein the VBG reflector body member is formed from, or comprises, a photo-thermo-refractive (PTR) material such as a PTR glass material.

15. A single-frequency laser apparatus according to claim 12, wherein the VBG reflector is defined by, or in, the optical gain material.

16. A single-frequency laser apparatus according to claim 1, comprising:
an optical pump such as a laser diode for generating an optical pump beam; and
one or more optical elements configured to optically couple the optical pump beam to the optical gain material so as to optically pump the optical gain material,
wherein the optical pump is configured to emit light at a wavelength in the range 450-530 nm, and optionally,
wherein the single-frequency laser apparatus comprises a further optical pump for generating a further optical pump beam,
wherein the one or more optical elements are configured to optically combine the optical pump beam and the further optical pump beam to form a combined optical pump beam, and to optically couple the combined optical pump beam to the optical gain material so as to optically pump the optical gain material, and
wherein one of the optical pump and the further optical pump is configured to emit light at a wavelength in one part of the range from 450-530 nm and the other one of the optical pump and the further optical pump is configured to emit light at a wavelength in a different part of the range from 450-530 nm.

17. (canceled)

18. A single-frequency laser apparatus according to claim 1, wherein at least one of:
the VBG reflector defines a refractive index profile which varies periodically along a length of the VBG reflector with a period which is different at different lateral positions across the VBG reflector; and
the VBG reflector defines a refractive index profile which varies periodically along the length of the VBG reflector with a period which varies, for example fans-out, according to a lateral position across the VBG reflector.

19. A single-frequency laser apparatus according to claim 18, wherein the mirror, the VBG reflector, and the optical gain material are arranged along an optical axis so that the intra-cavity beam propagates along the optical axis, wherein the VBG reflector is arranged with a length of the VBG reflector parallel to the optical axis, and wherein the VBG reflector and the optical axis are moveable laterally relative to one another so as to vary the period of the refractive index profile of the VBG reflector to which the intra-cavity beam is exposed and, optionally, wherein the single-frequency laser apparatus comprises a VBG reflector actuator for moving the VBG reflector laterally relative to the optical axis so as to vary the period of the refractive index profile of the VBG reflector to which the intra-cavity beam is exposed.

20. (canceled)

21. A single-frequency laser apparatus according to claim 1, comprising a heater for heating the VBG reflector and/or a cooler for cooling the VBG reflector.

22. A single-frequency laser apparatus according to claim 1, wherein the mirror, the VBG reflector, and the optical gain material are arranged along an optical axis so that the intra-cavity beam propagates along the optical axis, and wherein the single-frequency laser apparatus further comprises a mirror actuator for exerting a force on the mirror along the optical axis and/or moving the mirror along the optical axis and, optionally, wherein the mirror, the optical gain material, and the VBG reflector are unitary or are in engagement, and the mirror actuator is configured to compress the mirror, the optical gain material, and the VBG reflector against a fixed member in a direction parallel to the optical axis.

23. (canceled)

24. A single-frequency laser apparatus according to claim 1, comprising an electro-optic (EO) material such as MgO:LiNbO₃ located in the laser cavity.

25. A single-frequency laser apparatus according to claim 16, comprising a controller, wherein at least one of:
the controller is configured to control, vary and/or modulate the one or more optical elements so as to control, vary and/or modulate an optical power of at least one of the optical pump beam, the further optical pump beam, and the combined optical pump beam;
the controller is configured to control, vary and/or modulate an electrical current used to drive the optical pump so as to control, vary and/or modulate an optical power of the optical pump beam and/or the controller is configured to control, vary and/or modulate an electrical current used to drive the further optical pump so as to control, vary and/or modulate an optical power of the further optical pump beam;
the controller is configured to control the VBG reflector actuator so as to control the relative lateral alignment between the VBG reflector and the optical axis;
the controller is configured to control the heater so as to control a temperature of the VBG reflector;
the controller is configured to control the cooler so as to control a temperature of the VBG reflector;
the controller is configured to control the mirror actuator so as to control a compression force exerted on at least one of the mirror, the optical gain material, and the VBG reflector along the optical axis;
the controller is configured to control the mirror actuator so as to control a position of the mirror along the optical axis; and
the controller is configured to control, vary and/or modulate an electrical signal such as a voltage applied to the EO material.

26. A single-frequency laser apparatus according to claim 1, comprising:
a frequency-dependent optical transmission arrangement having a frequency-dependent optical transmission spectrum which defines a frequency-dependent slope or gradient in optical transmission around a frequency of an output beam emitted from the laser cavity;
one or more output optical elements for optically coupling at least a portion of the output beam emitted from the laser cavity to the frequency-dependent optical transmission arrangement; and
an optical detector for detecting an optical beam transmitted by the frequency-dependent optical transmission arrangement and for generating an electrical reference signal representative of an optical power of the optical beam transmitted by the frequency-dependent optical transmission arrangement.

27. A single-frequency laser apparatus according to claim 1, comprising:
a frequency-stabilised optical reference source such as a single-mode frequency-stabilised optical reference source or a frequency-stabilised optical frequency comb;
an optical detector; and
one or more output optical elements for optically coupling at least a portion of an output beam emitted from the laser cavity to the optical detector and for optically coupling at least a portion of an output beam emitted from the frequency-stabilised optical reference source to the optical detector so as to generate an electrical reference signal representative of a frequency difference between a frequency of the output beam emitted from the laser cavity and a frequency of the output beam emitted from the frequency-stabilised optical reference source.

28. A single-frequency laser apparatus according to claim 25, comprising a controller, wherein at least one of:
the controller is configured to control, vary and/or modulate an electrical signal such as a voltage applied to the EO material according to the electrical reference signal;
the controller is configured to control the mirror actuator so as to control the position of the mirror along the optical axis according to the electrical reference signal;
the controller is configured to control, vary and/or modulate the one or more optical elements so as to control, vary and/or modulate an optical power of at least one of the optical pump beam, the further optical pump beam, and the combined optical pump beam according to the electrical reference signal; and
the controller is configured to control, vary and/or modulate an electrical current used to drive the optical pump so as to control, vary and/or modulate an optical power of the optical pump beam according to the electrical reference signal and/or the controller is configured to control, vary and/or modulate an electrical current used to drive the further optical pump so as to control, vary and/or modulate an optical power of the further optical pump beam according to the electrical reference signal.

29. A single-frequency laser apparatus according to claim 1, wherein the optical gain material comprises at least one of:
a Ti:sapphire crystal;
a Cr²⁺-doped zinc chalcogenide such as Cr²⁺:ZnS or Cr²⁺:ZnSe;
Cr³⁺:BeAl₂O₄ (alexandrite);
a Cr³⁺-doped colquiriite such as LiSrAlF₆, LiSrGaF₆, or LiCaAlF₆;
Cr⁴⁺:Mg₂SiO₄ (forsterite); and
Cr⁴⁺:YAG.

30. A single-frequency laser apparatus according to claim 13, wherein the VBG reflector is defined by, or in, the optical gain material.
